(19) United States
(12) Patent Application Publication
(10) Pub. No.: US 2018/0293974 A1
(43) Pub. Date: Oct. 11, 2018

(54) SPOKEN LANGUAGE UNDERSTANDING BASED ON BUFFERED KEYWORD SPOTTING AND SPEECH RECOGNITION

(71) Applicant: INTEL IP CORPORATION, Santa Clara, CA (US)

(72) Inventors: Munir Nikolai Alexander Georges, Kehl (DE); Tobias Bocklet, Munich (DE); Georg Stemmer, Munich (DE); Joachim Hofer, Munich (DE); Josef G. Bauer, Munich (DE)

(73) Assignee: INTEL IP CORPORATION, Santa Clara, CA (US)

(21) Appl. No.: 15/483,421

(22) Filed: Apr. 10, 2017

(51) Int. Cl. G10L 15/04; G10L 15/28; G10L 15/18

(52) U.S. Cl. CPC G10L 15/04; G10L 2015/088; G10L 15/1822; G10L 15/285

(57) ABSTRACT

Techniques are provided for spoken language understanding based on keyword spotting and speech recognition. A methodology implementing the techniques according to an embodiment includes detecting a user spoken keyword or key-phrase embedded in an initial segment of a received audio signal, which is stored in a buffer. The method further includes triggering an automatic speech recognition (ASR) processor in response to the key-phrase detection. The method further includes performing automatic speech recognition, by the ASR processor, on a combination of the buffered initial segment and one or more additional received segments of the audio signal which include further speech from the user. The method still further includes performing natural language understanding on the recognized speech to determine a user request. The key-phrase is user selectable and serves to wake the ASR processor from a sleeping or idle lower power consumption state, into an active higher power consumption recognition state.

### BACKGROUND

Some computer systems or platforms become active or “wake-up” in response to the detection of a keyword or key-phrase spoken by the user. After wake-up, the computer proceeds to recognize and process the additional user speech that follows the keyword. Such systems employ speech recognition techniques and typically require that the user pause between the wake-up keyword and the remainder of the spoken request, in order to switch processing modes (e.g., from keyword spotting mode to full speech recognition mode). This forced pause may be achieved by playing a short jingle or generating some visual feedback to inform the user that the computer is ready to accept the remainder of the spoken request. This pause creates an interruption in the natural flow of speech and negatively impacts the quality of the user experience. Additionally, some systems require that the keyword be fixed rather than user selectable, which is also undesirable.

### BRIEF DESCRIPTION OF THE DRAWINGS

Features and advantages of embodiments of the claimed subject matter will become apparent as the following Detailed Description proceeds, and upon reference to the Drawings, wherein like numerals depict like parts.

FIG. 1 is a top-level block diagram of a spoken language understanding system, configured in accordance with certain embodiments of the present disclosure.

FIG. 2 is a more detailed block diagram of the spoken language understanding system, configured in accordance with certain embodiments of the present disclosure.

FIG. 3 is a flow diagram illustrating one example implementation of a spoken language understanding system.

FIG. 4 is a flow diagram illustrating an implementation of a spoken language understanding system, configured in accordance with certain embodiments of the present disclosure.

FIG. 5 is a flowchart illustrating a methodology for spoken language understanding, in accordance with certain embodiments of the present disclosure.

FIG. 6 is a block diagram schematically illustrating a computing platform configured to perform spoken language understanding, in accordance with certain embodiments of the present disclosure.

Although the following Detailed Description will proceed with reference being made to illustrative embodiments, many alternatives, modifications, and variations thereof will be apparent in light of this disclosure.

### DETAILED DESCRIPTION

Generally, this disclosure provides techniques for spoken language understanding based on a combination of keyword spotting and automatic speech recognition (ASR). Keyword spotting techniques are employed to detect the utterance, by a user, of a wake-up phrase and to trigger a speech processing system to subsequently recognize the full request spoken by the user including the wake-up phrase. The wake-up-phrase detection and speech processing system are effectively decoupled from one another at a model level, by providing independent models for both modules. The modules are connected via an electronic buffer memory (e.g., ring-buffer) where the subsequent recognition process is initiated by the wake-up-phrase detection process. The decoupling and buffering scheme allows these techniques to eliminate the requirement for a forced pause by the user between the wake-up phrase and the remainder of the spoken request. The techniques also allow the user to select or customize the system to detect any desired wake-up phrase.

The disclosed techniques can be implemented, for example, in a computing system or a software product executable or otherwise controllable by such systems, although other embodiments will be apparent. The system or product is configured to understand spoken language using a combination of keyword spotting and automatic speech recognition techniques. In accordance with an embodiment, a methodology to implement these techniques includes detecting a user spoken keyword or key-phrase embedded in an initial segment of a received audio signal, which is stored in a buffer for subsequent use by the ASR processor. The method further includes triggering the ASR processor, in response to the key-phrase detection, to perform automatic speech recognition on a combination of the buffered initial segment and one or more additional received segments of the audio signal. The additional received segments include further speech from the user. The method further includes performing natural language understanding on the recognized speech to determine a user request, which may then be executed or performed by a suitable application. The key-phrase is user-configurable or otherwise customizable or selectable, and detection of the key-phrase serves to wake the ASR processor from a sleeping or idle, lower power consumption state, into an active, higher power consumption recognition state.

As will be appreciated, the techniques described herein may allow for improved language understanding, compared to existing methods that process the user's spoken requests in isolation from the wake-up key-phrase. The disclosed techniques can be implemented on a broad range of platforms including laptops, tablets, smart phones, workstations, and imaging devices. These techniques may further be implemented in hardware or software or a combination thereof.

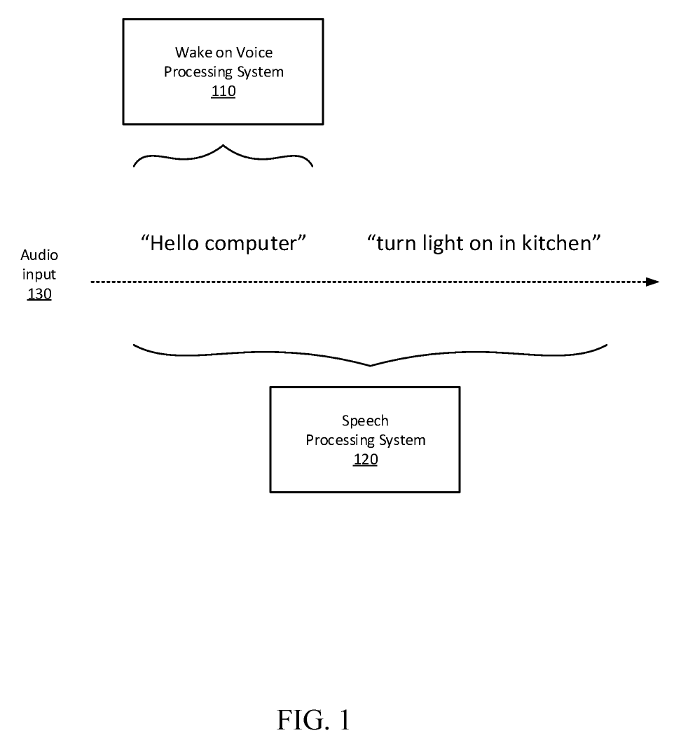

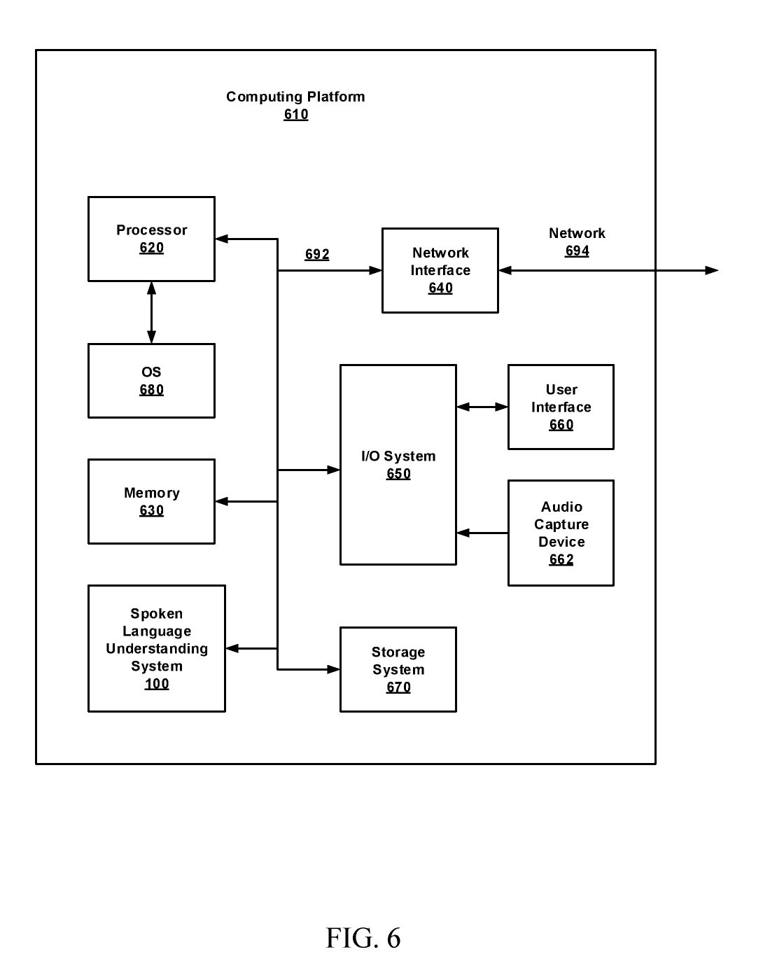

FIG. 1 is a top-level block diagram of a spoken language understanding system 100, configured in accordance with certain embodiments of the present disclosure. The spoken language understanding system 100 is shown to include a “wake on voice” (WOV) processing system 110 and a speech processing system 120. In some embodiments, the spoken language understanding system 100 may be hosted on a computing or communications platform, as described in greater detail in connection with FIG. 6 below.

An example of audio input 130 is shown to include speech from the user, in this example: “hello computer turn light on in kitchen.” The audio input may be provided by a microphone, an array of microphones (e.g., configured for beamforming), or other suitable audio capture device. The WOV processing system 110 is configured to detect the key-phrase “hello computer,” although any other user defined wake-up key-phrase may be used. The WOV processing system 110 is further configured to trigger the speech processing system 120 to recognize the entire spoken utterance including both the key-phrase and the remaining user request to turn on the kitchen lights. In some embodiments, the trigger may further be used to wake the computing platform, or any portion thereof, from a sleep or idle state to an active state. The operations of the WOV processing system 110 and the speech processing system 120 are described in greater detail below.

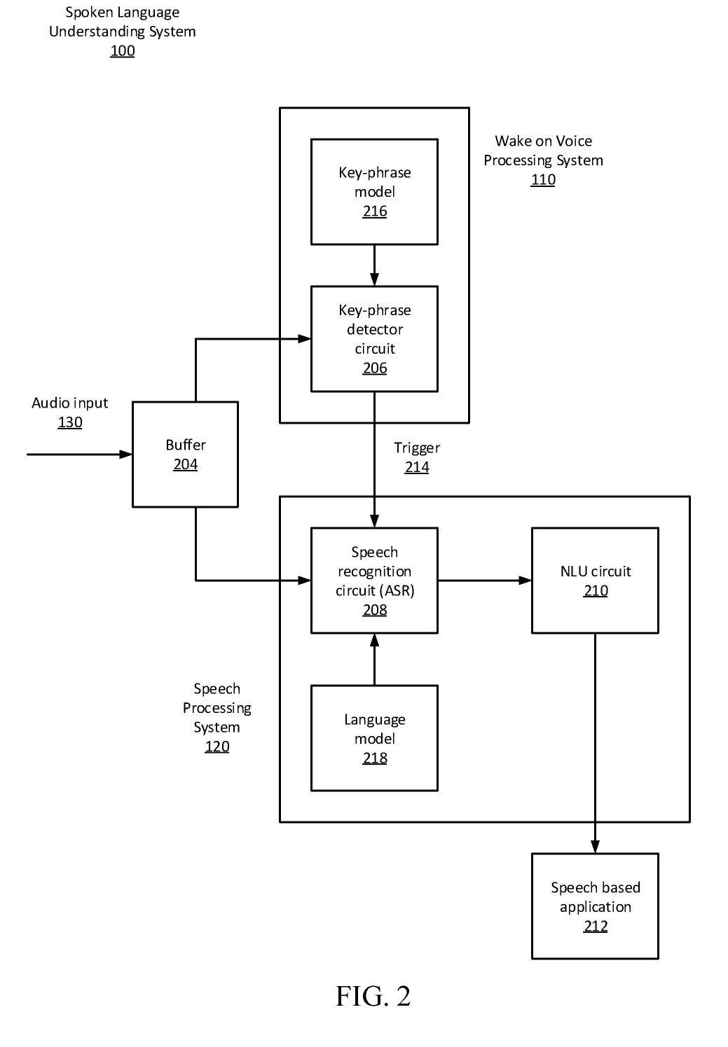

FIG. 2 is a more detailed block diagram of the spoken language understanding system 100, configured in accordance with certain embodiments of the present disclosure. The spoken language understanding system 100 is shown to include an audio buffer 204, a wake on voice (WOV) processing system 110, a speech processing system 120, and a speech based application 212. The WOV processing system 110 is shown to further include a key-phrase detector circuit 206 and a key-phrase model 216. The speech processing system 120 is shown to further include an automated speech recognition circuit (ASR) 208, a language model 218, and a natural language understanding (NLU) circuit 210.

The audio buffer 204 is configured to store received audio input signals 130 provided by an audio capture device such as, for example, a microphone or array of microphones. The audio signals may thus include segments of user speech (or extracted audio features from those segments) when the user is talking. In some embodiments, the audio buffer 204 may be sized to provide storage in excess of the longest anticipated keyword or key-phrase, so that the key-phrase can be made available for both the key-phrase detector circuit 206 and the ASR circuit 208, as described below. In some embodiments, the audio buffer 204 may be a circular buffer or ring buffer in which, for example, the oldest samples are overwritten by newer samples. In some embodiments, for example if memory capacity is limited, a smaller buffer size may be used (including, in an extreme case, a buffer size of zero). In such cases, the ASR phrase model may be modified to recognize partial phrases.

The key-phrase detector circuit 206 is configured to detect a user spoken key-phrase that is included in an initial segment of the received audio signal which is stored in the buffer 204. The key-phrase detector circuit is further configured to trigger the automatic speech recognition (ASR) circuit 208, in response to the key-phrase detection. In some embodiments, the trigger of the ASR circuit 208 may wake the ASR circuit or processor from a lower power consuming idle state to a relatively higher power consuming recognition state. In some embodiments, the trigger may further be employed to wake the computing platform, or any portion thereof, from a sleep or idle state to an active state.

In some embodiments, the key-phrase detector circuit 206 employs known keyword spotting techniques, in light of the present disclosure. These keyword spotting techniques may further employ a language model which includes the wake-up key-phrases, whether predefined or chosen by the user.

The ASR circuit 208 is configured to recognize user speech based on the buffered initial segment (e.g., the key-phrase) in combination with additional received segments of audio signal which include further speech of the user. In some embodiments, the ASR circuit 208 employs known speech recognition techniques, in light of the present disclosure. These speech recognition techniques may further employ a language model, separate from the keyword spotting language model, which includes the wake-up key-phrases in addition to a grammar of expected user requests. As a simplified example, the ASR language model could be a grammar that can recognize “[start|stop|pause] playback” and the key-phrase is “hello computer.” In this case, the combined grammar that is understood by the language model is “hello computer [start|stop|pause] playback.”

In accordance with the disclosed techniques, therefore, the key-phrase will be recognized twice. The first recognition is performed by the key-phrase detector circuit 206, which ignores speech after the key-phrase. The second recognition is performed by the ASR circuit 208, which recognizes the key-phrase in combination with the speech that follows. The second recognition increases the reliability of key-phrase detection (or rejection), since the ASR circuit 208 generally has improved discriminative capabilities compared to the WOV processing system 110, due to the fact that the WOV processing system 110 typically has restrictions on size, speed, power, and computational complexity, as it may need to remain in an active listening state for extended periods of time.

In some embodiments, the inclusion of the key-phrase in the ASR language model may be an optional component of that language model so that the same language model can be used in situations where the ASR is triggered by an event other than the key-phrase, such as, for example, a button push or other non-speech related activity.

The ASR circuit 208 is further configured to determine an endpoint of the user's speech, for example when the user has completed his request. The endpoint detection is typically based on a pause duration or a stability criterion of a best utterance hypothesis. To avoid confusion that may be caused by a pause in the speech of the user after the key-phrase, the endpoint detection technique requires that additional speech be received after the key-phrase, before an endpoint can be declared. Thus, the user can pause for an arbitrary length of time after the key-phrase is spoken, and the system will continue to listen for the remainder of the user's request.

In some further embodiments, the ASR circuit 208 is configured to transition from the higher power recognition state back to the lower power idle state after speech recognition is completed.

In some embodiments, the key-phrase detection processor or circuit 206 is configured to consume less power than the ASR processor or circuit 208, at least when the ASR processor is in the higher power consumption recognition state, allowing for power optimization between these two functions. For example, in some embodiments, the key-phrase detection circuit 206 may be implemented on a low power CPU or digital signal processor (DSP), and the ASR circuit 208 may be implemented on a hardware accelerator or suitably optimized coprocessor.

The NLU circuit 210 is configured to perform natural language understanding on a segment of the recognized speech to determine the meaning of the user request. So, for example, the ASR may recognize a string of words such as “turn light on in kitchen” or “turn kitchen lights on” in an audio signal, but the NLU interprets those words to determine the specific action that needs to be taken. Of course, the ASR may be configured to recognize not just a string of words, but more generally, any type of language representation, such as, for example, a sequence of phonemes or a word lattice, etc. In some embodiments, the segment of recognized speech provided to the NLU may begin after the key-phrase (since the key-phrase is not necessarily relevant to the user requested action) and terminate at the endpoint determined by the ASR. The removal of the key-phrase, prior to NLU also allows for changes in the key-phrase (or use of other ASR triggers including a button press) without requiring modification of the NLU. In some embodiments, however, the key-phrase may be used to modify or adapt the ASR and NLU models to a target domain. For example, multiple key-phrases such as “car music” and “car climate” may be used as a type of voice menu selection which can change the subsequent ASR and NLU processing.

One or more speech based applications 212 are configured to execute the user's request as determined by the NLU circuit 210. For example, the NLU may direct an application to complete a circuit that turns on the kitchen lights, or direct an automobile navigation system to perform a desired function.

In some embodiments, the spoken language understanding system 100 may be distributed among different components. For example, the WOV system 110 may be hosted on a wearable device such as a wristwatch, the ASR 208 may be hosted on a smart phone, while the NLU 210 may be hosted on a computer system of an automobile, although numerous other configurations and platforms are possible.

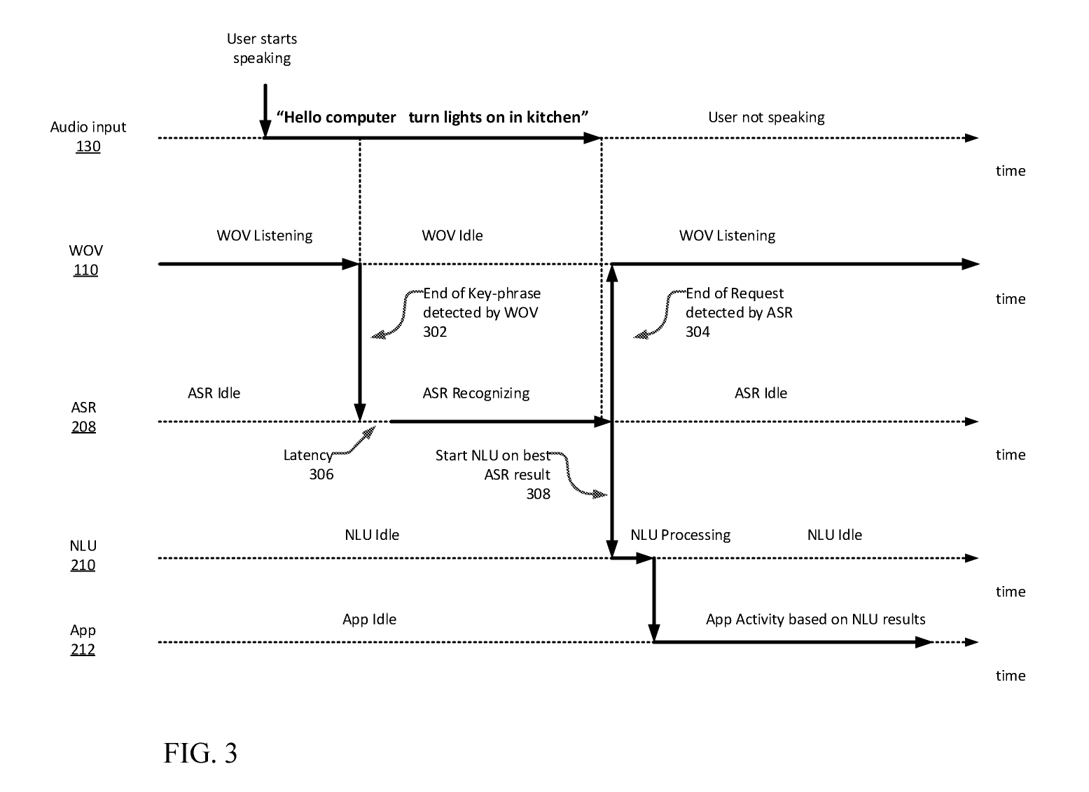

FIG. 3 is a flow diagram illustrating one example implementation of a spoken language understanding system in which the user is required to pause between the key-phrase and the remainder of the spoken request. The top timeline, which represents audio input 130, shows that the user begins speaking and says the words “hello computer turn lights on in kitchen.” The key-phrase is “hello computer” and the user request is “turn lights on in the kitchen. The WOV system 110 is shown to be in a listening state and it attempts to detect the endpoint of the key-phrase in the audio signal at 302. The endpoint detection cuts the audio signal to the WOV and triggers the ASR circuit 208 into a recognizing state in which it operates on the remaining audio signal. The NLU begins processing when the best (or first acceptable) ASR result becomes available at 308. When the endpoint of the request is detected by the ASR 304, the ASR enters an idle state and the WOV returns to a listening state awaiting the next key-phrase. Also shown is that the speech-based application activity commences when the NLU processing results become available.

Unfortunately, however, in this system there is a latency 306 between the detected endpoint of the key-phrase by the WOV and the beginning of the ASR recognition. Additionally, the length of the user pause may vary significantly, and detection of the endpoint of the key-phrase can be difficult which may cause a disruption in the beginning of the audio stream upon which the ASR operates. Due to the relatively imprecise cutting of the audio signal, a portion of the key-phrase may be included in the audio signal processed by the ASR, or a portion of the user request may be cut off from the ASR. For this reason, the ASR results may be incorrect at the beginning of the user request, causing the Natural Language Understanding (NLU) circuit 210 to misinterpret the request.

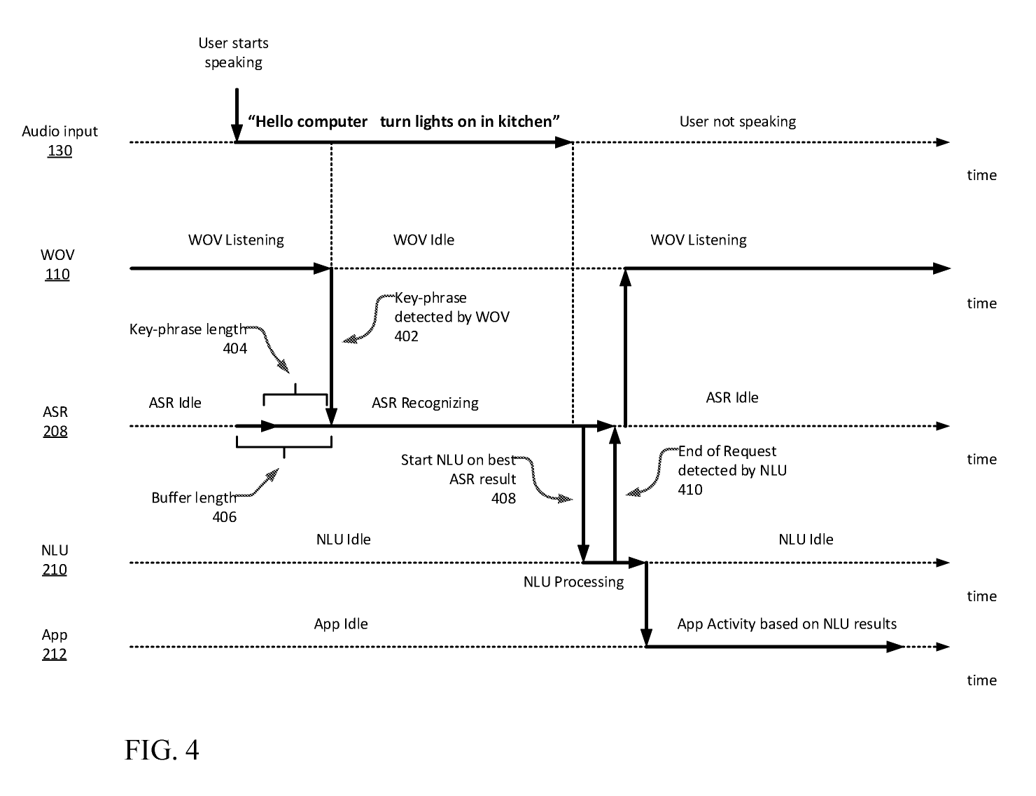

FIG. 4 is a flow diagram illustrating an implementation of a spoken language understanding system, configured in accordance with certain embodiments of the present disclosure. In this system, a buffer is provided to store the key-phrase as it is being detected by the WOV system 110, and for subsequent use by the ASR 208. In some embodiments, other techniques may be used to store the key-phrase, in light of the present disclosure. The buffer length 406 is greater than the key-phrase length 404. In some embodiments, for example, the buffer length may be configured to store more than one second of the audio input 130. Because the key-phrase is stored in the buffer, the WOV detects the key-phrase but does not need to detect the precise endpoint of the key-phrase. Once the WOV detects the key-phrase 402 (which may occur shortly before or after the user completes speaking the key-phrase), the ASR is triggered and provided with the audio from the buffer and all subsequent audio. Thus, the ASR receives all of the audio that was spoken by the user including the key-phrase at the beginning of the utterance as well as the remainder of the user's request, and does not need to rely on an endpoint determination by the WOV.

The NLU begins processing when the best ASR result (e.g., the highest scoring ASR hypothesis or result) becomes available at 408. In some embodiments, the endpoint of the request may be detected by the NLU 410, rather than the ASR, in which case semantic information associated with meaning of the user's request can aid in the determination of the endpoint. The ASR then enters an idle state and the WOV returns to a listening state awaiting the next key-phrase.

Methodology

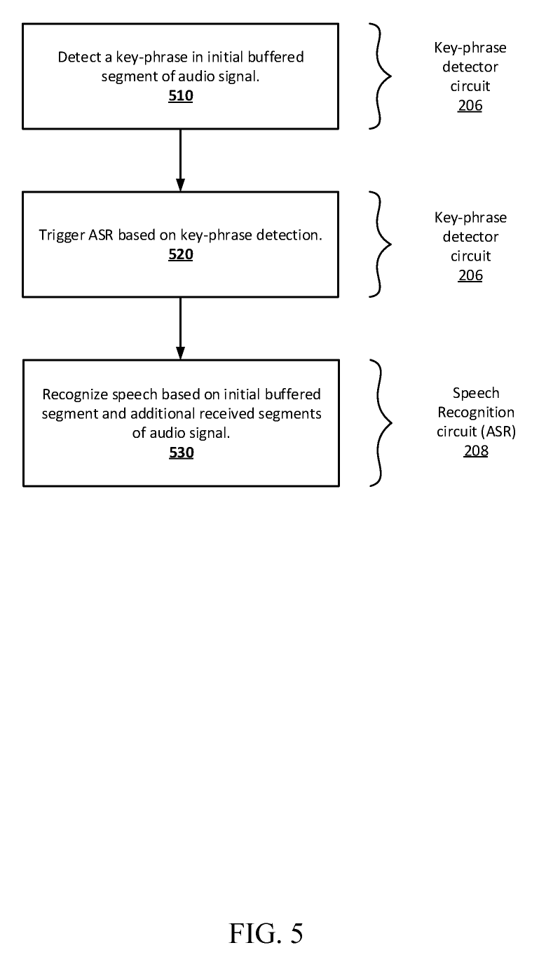

FIG. 5 is a flowchart illustrating an example method 500 for spoken language understanding, in accordance with certain embodiments of the present disclosure. As can be seen, the example method includes a number of phases and sub-processes, the sequence of which may vary from one embodiment to another. However, when considered in the aggregate, these phases and sub-processes form a process for spoken language understanding in accordance with certain of the embodiments disclosed herein. These embodiments can be implemented, for example using the system architecture illustrated in FIG. 2 as described above. However other system architectures can be used in other embodiments, as will be apparent in light of this disclosure. To this end, the correlation of the various functions shown in FIG. 5 to the specific components illustrated in the other figures is not intended to imply any structural and/or use limitations. Rather, other embodiments may include, for example, varying degrees of integration wherein multiple functionalities are effectively performed by one system. For example, in an alternative embodiment a single module having decoupled sub-modules can be used to perform all of the functions of method 500, wherein a buffering scheme is utilized as provided herein. Thus, other embodiments may have fewer or more modules and/or sub-modules depending on the granularity of implementation. In still other embodiments, the methodology depicted can be implemented as a computer program product including one or more non-transitory machine readable mediums that when executed by one or more processors cause the methodology to be carried out. Numerous variations and alternative configurations will be apparent in light of this disclosure.

As illustrated in FIG. 5, in an embodiment, method 500 for spoken language understanding commences by detecting, at operation 510, a user spoken key-phrase included in an initial segment of an audio signal (or features extracted from an audio signal). In some embodiments, the key-phrases detected by a key-phrase or keyword spotting processor. The initial segment is stored in a buffer.

Next, at operation 520, an automatic speech recognition (ASR) processor is triggered, in response to the key-phrase detection. In some embodiments, the triggering of the ASR processor comprises waking the ASR processor from a relatively lower power consumption idle state, to a relatively higher power consumption recognition state.

At operation 530, the ASR processor recognizes speech based on a combination of both the buffered initial segment and on one or more additional received segments of the audio signal which include further speech from the user. In some embodiments, the key-phrase is included in the language model used by the key-phrase processor and in the language model used by the ASR processor. In some embodiments, the ASR language model may be a statistical language model based on a Markov N-gram model, a grammar model, or a recurrent neural network.

Of course, in some embodiments, additional operations may be performed, as previously described in connection with the system. For example, an endpoint of the recognized speech may be determined by the ASR processor, after additional speech (beyond the key-phrase) is received, thus allowing the user to insert an arbitrarily long pause after the key-phrase. In some embodiments, a user interface may be configured to permit the user to specify a selected timeout parameter to prevent the system from becoming nonresponsive. Additionally, in some embodiments, natural language understanding may be performed on the recognized speech to determine the user's request and to execute an appropriate application to handle that request. In some further embodiments, the ASR processor may be transitioned from the higher power recognition state to a lower power idle state after speech recognition is completed.

Example System

FIG. 6 illustrates an example system 600 to perform spoken language understanding, configured in accordance with certain embodiments of the present disclosure. In some embodiments, system 600 comprises a computing platform 610 which may host, or otherwise be incorporated into a personal computer, workstation, server system, laptop computer, ultra-laptop computer, tablet, touchpad, portable computer, handheld computer, palmtop computer, personal digital assistant (PDA), cellular telephone, combination cellular telephone and PDA, smart device (for example, smartphone or smart tablet), mobile internet device (MID), messaging device, data communication device, imaging device, and so forth. Any combination of different devices may be used in certain embodiments.

In some embodiments, platform 610 may comprise any combination of a processor 620, a memory 630, spoken language understanding system 100, a network interface 640, an input/output (I/O) system 650, a user interface 660, an audio capture device 662, and a storage system 670. As can be further seen, a bus and/or interconnect 692 is also provided to allow for communication between the various components listed above and/or other components not shown. Platform 610 can be coupled to a network 694 through network interface 640 to allow for communications with other computing devices, platforms, or resources. Other componentry and functionality not reflected in the block diagram of FIG. 6 will be apparent in light of this disclosure, and it will be appreciated that other embodiments are not limited to any particular hardware configuration.

Processor 620 can be any suitable processor, and may include one or more coprocessors or controllers, such as an audio processor, a graphics processing unit, or hardware accelerator, to assist in control and processing operations associated with system 600. In some embodiments, the processor 620 may be implemented as any number of processor cores. The processor (or processor cores) may be any type of processor, such as, for example, a micro-processor, an embedded processor, a digital signal processor (DSP), a graphics processor (GPU), a network processor, a field programmable gate array or other device configured to execute code. The processors may be multithreaded cores in that they may include more than one hardware thread context (or “logical processor”) per core. Processor 620 may be implemented as a complex instruction set computer (CISC) or a reduced instruction set computer (RISC) processor. In some embodiments, processor 620 may be configured as an x86 instruction set compatible processor.

Memory 630 can be implemented using any suitable type of digital storage including, for example, flash memory and/or random access memory (RAM). In some embodiments, the memory 630 may include various layers of memory hierarchy and/or memory caches as are known to those of skill in the art. Memory 630 may be implemented as a volatile memory device such as, but not limited to, a RAM, dynamic RAM (DRAM), or static RAM (SRAM) device. Storage system 670 may be implemented as a non-volatile storage device such as, but not limited to, one or more of a hard disk drive (HDD), a solid-state drive (SSD), a universal serial bus (USB) drive, an optical disk drive, tape drive, an internal storage device, an attached storage device, flash memory, battery backed-up synchronous DRAM (SDRAM), and/or a network accessible storage device. In some embodiments, storage 670 may comprise technology to increase the storage performance enhanced protection for valuable digital media when multiple hard drives are included.

Processor 620 may be configured to execute an Operating System (OS) 680 which may comprise any suitable operating system, such as Google Android (Google Inc., Mountain View, Calif.), Microsoft Windows (Microsoft Corp., Redmond, Wash.), Apple OS X (Apple Inc., Cupertino, Calif.), Linux, or a real-time operating system (RTOS). As will be appreciated in light of this disclosure, the techniques provided herein can be implemented without regard to the particular operating system provided in conjunction with system 600, and therefore may also be implemented using any suitable existing or subsequently-developed platform.

Network interface circuit 640 can be any appropriate network chip or chipset which allows for wired and/or wireless connection between other components of computer system 600 and/or network 694, thereby enabling system 600 to communicate with other local and/or remote computing systems, servers, cloud-based servers, and/or other resources. Wired communication may conform to existing (or yet to be developed) standards, such as, for example, Ethernet. Wireless communication may conform to existing (or yet to be developed) standards, such as, for example, cellular communications including LTE (Long Term Evolution), Wireless Fidelity (Wi-Fi), Bluetooth, and/or Near Field Communication (NFC). Exemplary wireless networks include, but are not limited to, wireless local area networks, wireless personal area networks, wireless metropolitan area networks, cellular networks, and satellite networks.

I/O system 650 may be configured to interface between various I/O devices and other components of computer system 600. I/O devices may include, but not be limited to, user interface 660 and audio capture device 662 (e.g., a microphone). User interface 660 may include devices (not shown) such as a display element, touchpad, keyboard, mouse, and speaker, etc. I/O system 650 may include a graphics subsystem configured to perform processing of images for rendering on a display element. Graphics subsystem may be a graphics processing unit or a visual processing unit (VPU), for example. An analog or digital interface may be used to communicatively couple graphics subsystem and the display element. For example, the interface may be any of a high definition multimedia interface (HDMI), DisplayPort, wireless HDMI, and/or any other suitable interface using wireless high definition compliant techniques. In some embodiments, the graphics subsystem could be integrated into processor 620 or any chipset of platform 610.

It will be appreciated that in some embodiments, the various components of the system 600 may be combined or integrated in a system-on-a-chip (SoC) architecture. In some embodiments, the components may be hardware components, firmware components, software components or any suitable combination of hardware, firmware or software.

Spoken language understanding system 100 is configured to perform spoken language understanding based on a combination of keyword spotting and speech recognition, as described previously. Spoken language understanding system 100 may include any or all of the circuits/components illustrated in FIG. 2, as described above. These components can be implemented or otherwise used in conjunction with a variety of suitable software and/or hardware that is coupled to or that otherwise forms a part of platform 610. These components can additionally or alternatively be implemented or otherwise used in conjunction with user I/O devices that are capable of providing information to, and receiving information and commands from, a user.

In some embodiments, these circuits may be installed local to system 600, as shown in the example embodiment of FIG. 6. Alternatively, system 600 can be implemented in a client-server arrangement wherein at least some functionality associated with these circuits is provided to system 600 using an applet, such as a JavaScript applet, or other downloadable module or set of sub-modules. Such remotely accessible modules or sub-modules can be provisioned in real-time, in response to a request from a client computing system for access to a given server having resources that are of interest to the user of the client computing system. In such embodiments, the server can be local to network 694 or remotely coupled to network 694 by one or more other networks and/or communication channels. In some cases, access to resources on a given network or computing system may require credentials such as usernames, passwords, and/or compliance with any other suitable security mechanism.

In various embodiments, system 600 may be implemented as a wireless system, a wired system, or a combination of both. When implemented as a wireless system, system 600 may include components and interfaces suitable for communicating over a wireless shared media, such as one or more antennae, transmitters, receivers, transceivers, amplifiers, filters, control logic, and so forth. An example of wireless shared media may include portions of a wireless spectrum, such as the radio frequency spectrum and so forth. When implemented as a wired system, system 600 may include components and interfaces suitable for communicating over wired communications media, such as input/output adapters, physical connectors to connect the input/output adaptor with a corresponding wired communications medium, a network interface card (NIC), disc controller, video controller, audio controller, and so forth. Examples of wired communications media may include a wire, cable metal leads, printed circuit board (PCB), backplane, switch fabric, semiconductor material, twisted pair wire, coaxial cable, fiber optics, and so forth.

Various embodiments may be implemented using hardware elements, software elements, or a combination of both. Examples of hardware elements may include processors, microprocessors, circuits, circuit elements (for example, transistors, resistors, capacitors, inductors, and so forth), integrated circuits, ASICs, programmable logic devices, digital signal processors, FPGAs, logic gates, registers, semiconductor devices, chips, microchips, chipsets, and so forth. Examples of software may include software components, programs, applications, computer programs, application programs, system programs, machine programs, operating system software, middleware, firmware, software modules, routines, subroutines, functions, methods, procedures, software interfaces, application program interfaces, instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power level, heat tolerances, processing cycle budget, input data rates, output data rates, memory resources, data bus speeds, and other design or performance constraints.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still cooperate or interact with each other.

The various embodiments disclosed herein can be implemented in various forms of hardware, software, firmware, and/or special purpose processors. For example, in one embodiment at least one non-transitory computer readable storage medium has instructions encoded thereon that, when executed by one or more processors, cause one or more of the spoken language understanding methodologies disclosed herein to be implemented. The instructions can be encoded using a suitable programming language, such as C, C++, object oriented C, Java, JavaScript, Visual Basic .NET, Beginner's All-Purpose Symbolic Instruction Code (BASIC), or alternatively, using custom or proprietary instruction sets. The instructions can be provided in the form of one or more computer software applications and/or applets that are tangibly embodied on a memory device, and that can be executed by a computer having any suitable architecture. In one embodiment, the system can be hosted on a given website and implemented, for example, using JavaScript or another suitable browser-based technology. For instance, in certain embodiments, the system may leverage processing resources provided by a remote computer system accessible via network 694. In other embodiments, the functionalities disclosed herein can be incorporated into other software applications, such as robotics, gaming, and virtual reality applications. The computer software applications disclosed herein may include any number of different modules, sub-modules, or other components of distinct functionality, and can provide information to, or receive information from, still other components. These modules can be used, for example, to communicate with input and/or output devices such as a display screen, a touch sensitive surface, a printer, and/or any other suitable device. Other componentry and functionality not reflected in the illustrations will be apparent in light of this disclosure, and it will be appreciated that other embodiments are not limited to any particular hardware or software configuration. Thus, in other embodiments system 600 may comprise additional, fewer, or alternative subcomponents as compared to those included in the example embodiment of FIG. 6.

The aforementioned non-transitory computer readable medium may be any suitable medium for storing digital information, such as a hard drive, a server, a flash memory, and/or random access memory (RAM), or a combination of memories. In alternative embodiments, the components and/or modules disclosed herein can be implemented with hardware, including gate level logic such as a field-programmable gate array (FPGA), or alternatively, a purpose-built semiconductor such as an application-specific integrated circuit (ASIC). Still other embodiments may be implemented with a microcontroller having a number of input/output ports for receiving and outputting data, and a number of embedded routines for carrying out the various functionalities disclosed herein. It will be apparent that any suitable combination of hardware, software, and firmware can be used, and that other embodiments are not limited to any particular system architecture.

Some embodiments may be implemented, for example, using a machine readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, process, or the like, and may be implemented using any suitable combination of hardware and/or software. The machine readable medium or article may include, for example, any suitable type of memory unit, memory device, memory article, memory medium, storage device, storage article, storage medium, and/or storage unit, such as memory, removable or non-removable media, erasable or non-erasable media, writeable or rewriteable media, digital or analog media, hard disk, floppy disk, compact disk read only memory (CD-ROM), compact disk recordable (CD-R) memory, compact disk rewriteable (CR-RW) memory, optical disk, magnetic media, magneto-optical media, removable memory cards or disks, various types of digital versatile disk (DVD), a tape, a cassette, or the like. The instructions may include any suitable type of code, such as source code, compiled code, interpreted code, executable code, static code, dynamic code, encrypted code, and the like, implemented using any suitable high level, low level, object oriented, visual, compiled, and/or interpreted programming language.

Unless specifically stated otherwise, it may be appreciated that terms such as “processing,” “computing,” “calculating,” “determining,” or the like refer to the action and/or process of a computer or computing system, or similar electronic computing device, that manipulates and/or transforms data represented as physical quantities (for example, electronic) within the registers and/or memory units of the computer system into other data similarly represented as physical quantities within the registers, memory units, or other such information storage transmission or displays of the computer system. The embodiments are not limited in this context.

The terms “circuit” or “circuitry,” as used in any embodiment herein, are functional and may comprise, for example, singly or in any combination, hardwired circuitry, programmable circuitry such as computer processors comprising one or more individual instruction processing cores, state machine circuitry, and/or firmware that stores instructions executed by programmable circuitry. The circuitry may include a processor and/or controller configured to execute one or more instructions to perform one or more operations described herein. The instructions may be embodied as, for example, an application, software, firmware, etc. configured to cause the circuitry to perform any of the aforementioned operations. Software may be embodied as a software package, code, instructions, instruction sets and/or data recorded on a computer-readable storage device. Software may be embodied or implemented to include any number of processes, and processes, in turn, may be embodied or implemented to include any number of threads, etc., in a hierarchical fashion. Firmware may be embodied as code, instructions or instruction sets and/or data that are hard-coded (e.g., nonvolatile) in memory devices. The circuitry may, collectively or individually, be embodied as circuitry that forms part of a larger system, for example, an integrated circuit (IC), an application-specific integrated circuit (ASIC), a system-on-a-chip (SoC), desktop computers, laptop computers, tablet computers, servers, smart phones, etc. Other embodiments may be implemented as software executed by a programmable control device. In such cases, the terms “circuit” or “circuitry” are intended to include a combination of software and hardware such as a programmable control device or a processor capable of executing the software. As described herein, various embodiments may be implemented using hardware elements, software elements, or any combination thereof. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

Numerous specific details have been set forth herein to provide a thorough understanding of the embodiments. It will be understood by an ordinarily-skilled artisan, however, that the embodiments may be practiced without these specific details. In other instances, well known operations, components and circuits have not been described in detail so as not to obscure the embodiments. It can be appreciated that the specific structural and functional details disclosed herein may be representative and do not necessarily limit the scope of the embodiments. In addition, although the subject matter has been described in language specific to structural features and/or methodological acts, it is to be understood that the subject matter defined in the appended claims is not necessarily limited to the specific features or acts described herein. Rather, the specific features and acts described herein are disclosed as example forms of implementing the claims.

### Further Example Embodiments

The following examples pertain to further embodiments, from which numerous permutations and configurations will be apparent.

Example 1 is a method for spoken language understanding. The method comprises: detecting, by a key-phrase processor, a user spoken key-phrase included in an initial segment of an audio signal, the initial segment stored in a buffer; triggering, by the key-phrase processor, an automatic speech recognition (ASR) processor, in response to the key-phrase detection; and recognizing speech, by the ASR processor, based on the buffered initial segment and further based on additional received segments of the audio signal, the additional received segment including further speech of the user.

Example 2 includes the subject matter of Example 1, wherein the triggering of the ASR processor comprises waking the ASR processor from a lower power consuming idle state to a higher power consuming recognition state.

Example 3 includes the subject matter of Examples 1 or 2, further comprising: including the key-phrase in a first language model for use by the key-phrase processor; and including the key-phrase in a second language model for use by the ASR processor, the second language model different from the first language model.

Example 4 includes the subject matter of any of Examples 1-3, further comprising determining an endpoint of the recognized speech, the endpoint determination requiring at least one of the additional received segments to be received after the key-phrase.

Example 5 includes the subject matter of any of Examples 1-4, further comprising performing natural language understanding on a segment of the recognized speech to determine a user request, the segment of the recognized speech terminated by the endpoint.

Example 6 includes the subject matter of any of Examples 1-5, further comprising removing the key-phrase from the segment of the recognized speech prior to performing the natural language understanding.

Example 7 includes the subject matter of any of Examples 1-6, further comprising transitioning the ASR processor from a higher power consuming recognition state to a lower power consuming idle state after speech recognition is completed.

Example 8 includes the subject matter of any of Examples 1-7, wherein the key-phrase processor consumes less power than the ASR processor when the ASR processor is in the higher power consuming recognition state.

Example 9 includes the subject matter of any of Examples 1-8, wherein the key-phrase is user-configurable.

Example 10 is a system for spoken language understanding. The system comprises: a buffer for electronically storing audio signals; a key-phrase detector circuit to detect a user spoken key-phrase included in an initial segment of an audio signal, the initial segment stored in the buffer; and an automatic speech recognition (ASR) circuit; the key-phrase detector circuit further to trigger the ASR circuit, in response to the key-phrase detection; and the ASR circuit to recognize speech based on the buffered initial segment and further based on additional received segments of the audio signal, the additional received segment including further speech of the user.

Example 11 includes the subject matter of Example 10, wherein the triggering of the ASR circuit comprises waking the ASR circuit from a lower power consuming idle state to a higher power consuming recognition state.

Example 12 includes the subject matter of Examples 10 or 11, further comprising: a key-phrase model for use by the key-phrase circuit; and a language model for use by the ASR circuit, the key-phrase model and the language model different from one another and both configured to include the key-phrase stored in the buffer.

Example 13 includes the subject matter of any of Examples 10-12, wherein the ASR circuit is further to determine an endpoint of the recognized speech, the endpoint determination requiring at least one of the additional received segments to be received after the key-phrase.

Example 14 includes the subject matter of any of Examples 10-13, further comprising a natural language understanding circuit to perform natural language understanding on a segment of the recognized speech to determine a user request, the segment of the recognized speech terminated by the endpoint.

Example 15 includes the subject matter of any of Examples 10-14, wherein the ASR circuit is further to remove the key-phrase from the segment of the recognized speech prior to providing the segments of the recognized speech to the natural language understanding circuit.

Example 16 includes the subject matter of any of Examples 10-15, wherein the ASR circuit is further to transition from a higher power consuming recognition state to a lower power consuming idle state after speech recognition is completed, and wherein the key-phrase detector circuit consumes less power than the ASR circuit when the ASR circuit is in the higher power consuming recognition state.

Example 17 includes the subject matter of any of Examples 10-16, wherein the buffer is configured as a ring buffer, and the key-phrase is user-configurable.

Example 18 includes the subject matter of any of Examples 10-17, wherein the key phrase detector circuit is hosted on a wearable device and the ASR circuit is hosted on a smart phone.

Example 19 is at least one non-transitory computer readable storage medium having instructions encoded thereon that, when executed by one or more processors, result in the following operations for spoken language understanding. The operations comprise: detecting a user spoken key-phrase included in an initial segment of an audio signal, the initial segment stored in a buffer; triggering an automatic speech recognition (ASR) in response to the key-phrase detection; and recognizing speech based on the buffered initial segment and further based on additional received segments of the audio signal, the additional received segment including further speech of the user.

Example 20 includes the subject matter of Example 19, the operations further comprising: including the key-phrase in a first language model for the key-phrase detecting; and including the key-phrase in a second language model for the ASR, the second language model different from the first language model.

Example 21 includes the subject matter of Examples 19 or 20, the operations further comprising determining an endpoint of the recognized speech, the endpoint determination requiring at least one of the additional received segments to be received after the key-phrase.

Example 22 includes the subject matter of any of Examples 19-21, the operations further comprising performing natural language understanding on a segment of the recognized speech to determine a user request, the segment of the recognized speech terminated by the endpoint.

Example 23 includes the subject matter of any of Examples 19-22, the operations further comprising removing the key-phrase from the segment of the recognized speech prior to performing the natural language understanding.

Example 24 includes the subject matter of any of Examples 19-23, wherein the triggering of the ASR comprises the operation of waking an ASR processor from a lower power consuming idle state to a higher power consuming recognition state, the ASR processor configured to perform at least some portion of the speech recognition.

Example 25 includes the subject matter of any of Examples 19-24, the operations further comprising transitioning the ASR processor from a higher power consuming recognition state to a lower power consuming idle state after speech recognition is completed.

Example 26 is a system for spoken language understanding The system comprises: means for detecting a user spoken key-phrase included in an initial segment of an audio signal, the initial segment stored in a buffer; triggering an automatic speech recognition (ASR) processor, in response to the key-phrase detection; and recognizing speech based on the buffered initial segment and further based on additional received segments of the audio signal, the additional received segment including further speech of the user.

Example 27 includes the subject matter of Example 26, wherein the triggering of the ASR processor comprises waking the ASR processor from a lower power consuming idle state to a higher power consuming recognition state.

Example 28 includes the subject matter of Examples 26 or 27, further comprising: including the key-phrase in a first language model for use by a key-phrase processor; and including the key-phrase in a second language model for use by the ASR processor, the second language model different from the first language model.

Example 29 includes the subject matter of any of Examples 26-28, further comprising determining an endpoint of the recognized speech, the endpoint determination requiring at least one of the additional received segments to be received after the key-phrase.

Example 30 includes the subject matter of any of Examples 26-29, further comprising performing natural language understanding on a segment of the recognized speech to determine a user request, the segment of the recognized speech terminated by the endpoint.

Example 31 includes the subject matter of any of Examples 26-30, further comprising removing the key-phrase from the segment of the recognized speech prior to performing the natural language understanding.

Example 32 includes the subject matter of any of Examples 26-31, further comprising transitioning the ASR processor from a higher power consuming recognition state to a lower power consuming idle state after speech recognition is completed.

Example 33 includes the subject matter of any of Examples 26-32, wherein the key-phrase processor consumes less power than the ASR processor when the ASR processor is in the higher power consuming recognition state.

Example 34 includes the subject matter of any of Examples 26-33, wherein the key-phrase is user-configurable.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications. It is intended that the scope of the present disclosure be limited not be this detailed description, but rather by the claims appended hereto. Future filed applications claiming priority to this application may claim the disclosed subject matter in a different manner, and may generally include any set of one or more elements as variously disclosed or otherwise demonstrated herein.

1. A method for spoken language understanding, the method comprising:
detecting, by a key-phrase processor, a user spoken key-phrase included in an initial segment of an audio signal, the initial segment stored in a buffer;
triggering, by the key-phrase processor, an automatic speech recognition (ASR) processor, in response to the key-phrase detection;
recognizing speech, by the ASR processor, based on the buffered initial segment and further based on additional received segments of the audio signal, the additional received segment including further speech of the user; and
determining, by the ASR processor, an endpoint of the recognized speech, the endpoint determination requiring at least one of the additional received segments to be received after the key-phrase.

2. The method of claim 1, wherein the triggering of the ASR processor comprises waking the ASR processor from a lower power consuming idle state to a higher power consuming recognition state.

3. The method of claim 1, further comprising: including the key-phrase in a first language model for use by the key-phrase processor; and including the key-phrase in a second language model for use by the ASR processor, the second language model different from the first language model.

4. The method of claim 1, wherein the determined endpoint does not occur between the key-phrase and a first of the additional received segments.

5. The method of claim 1, further comprising performing natural language understanding on a segment of the recognized speech to determine a user request, the segment of the recognized speech terminated by the endpoint.

6. The method of claim 5, further comprising removing the key-phrase from the segment of the recognized speech prior to performing the natural language understanding.

7. The method of claim 1, further comprising transitioning the ASR processor from a higher power consuming recognition state to a lower power consuming idle state after speech recognition is completed.

8. The method of claim 7, wherein the key-phrase processor consumes less power than the ASR processor when the ASR processor is in the higher power consuming recognition state.

9. The method of claim 1, wherein the key-phrase is user-configurable.

10. A system for spoken language understanding, the system comprising:
a buffer for electronically storing audio signals;
a key-phrase detector circuit to detect a user spoken key-phrase included in an initial segment of an audio signal, the initial segment stored in the buffer; and
an automatic speech recognition (ASR) circuit;
the key-phrase detector circuit further to trigger the ASR circuit, in response to the key-phrase detection;
the ASR circuit to recognize speech based on the buffered initial segment and further based on additional received segments of the audio signal, the additional received segment including further speech of the user; and
the ASR circuit further to determine an endpoint of the recognized speech, the endpoint determination requiring at least one of the additional received segments to be received after the key-phrase.

11. The system of claim 10, wherein the triggering of the ASR circuit comprises waking the ASR circuit from a lower power consuming idle state to a higher power consuming recognition state.

12. The system of claim 10, further comprising: a key-phrase model for use by the key-phrase circuit; and a language model for use by the ASR circuit, the key-phrase model and the language model different from one another and both configured to include the key-phrase stored in the buffer.

13. The system of claim 10, wherein the determined endpoint does not occur between the key-phrase and a first of the additional received segments.

14. The system of claim 10, further comprising a natural language understanding circuit to perform natural language understanding on a segment of the recognized speech to determine a user request, the segment of the recognized speech terminated by the endpoint.

15. The system of claim 14, wherein the ASR circuit is further to remove the key-phrase from the segment of the recognized speech prior to providing the segments of the recognized speech to the natural language understanding circuit.

16. The system of claim 10, wherein the ASR circuit is further to transition from a higher power consuming recognition state to a lower power consuming idle state after speech recognition is completed, and wherein the key-phrase detector circuit consumes less power than the ASR circuit when the ASR circuit is in the higher power consuming recognition state.

17. The system of claim 10, wherein the buffer is configured as a ring buffer, and the key-phrase is user-configurable.

18. The system of claim 10, wherein the key phrase detector circuit is hosted on a wearable device and the ASR circuit is hosted on a smart phone.

19. At least one non-transitory computer readable storage medium having instructions encoded thereon that, when executed by one or more processors, result in the following operations for spoken language understanding, the operations comprising:
detecting a user spoken key-phrase included in an initial segment of an audio signal, the initial segment stored in a buffer;
triggering an automatic speech recognition (ASR) in response to the key-phrase detection;
recognizing speech based on the buffered initial segment and further based on additional received segments of the audio signal, the additional received segment including further speech of the user; and
determining an endpoint of the recognized speech, the endpoint determination requiring at least one of the additional received segments to be received after the key-phrase.

20. The computer readable storage medium of claim 19, the operations further comprising: including the key-phrase in a first language model for the key-phrase detecting; and including the key-phrase in a second language model for the ASR, the second language model different from the first language model.

21. The computer readable storage medium of claim 19, wherein the determined endpoint does not occur between the key-phrase and a first of the additional received segments.

22. The computer readable storage medium of claim 19, the operations further comprising performing natural language understanding on a segment of the recognized speech to determine a user request, the segment of the recognized speech terminated by the endpoint.

23. The computer readable storage medium of claim 22, the operations further comprising removing the key-phrase from the segment of the recognized speech prior to performing the natural language understanding.

24. The computer readable storage medium of claim 19, wherein the triggering of the ASR is performed by a key-phrase processor operating in a low-power mode and the triggering comprises the operation of waking an ASR processor from a lower power consuming idle state to a higher power consuming recognition state, the ASR processor configured to perform at least some portion of the speech recognition.

25. The computer readable storage medium of claim 24, the operations further comprising transitioning the ASR processor from a higher power consuming recognition state to a lower power consuming idle state after speech recognition is completed.
